(19) United States
(12) Patent Application Publication
(10) Pub. No.: US 2013/0343793 A1
(43) Pub. Date: Dec. 26, 2013

(54) IMAGE FORMING APPARATUS

(71) Applicant: Konica Minolta, Inc., Tokyo (JP)

(72) Inventors: Yusuke NISHISAKA, Tokyo (JP); Satoshi NISHIDA, Saitama (JP)

(21) Appl. No.: 13/924,057

(22) Filed: Jun. 21, 2013

(30) Foreign Application Priority Data
Jun. 25, 2012 (JP) 2012-142004

(51) Int. Cl. G03G 21/00

(52) U.S. Cl. CPC G03G 15/0805
USPC 399/346; 399/353

(57) ABSTRACT

An image forming apparatus including: a rotatable image bearing member; and a brush roller that rotates in a counter direction to a rotational direction of the image bearing member with a bristle portion being in sliding contact with an image bearing surface of the image bearing member. The bristle portion is inclined forward in the rotational direction of the brush roller.

### CROSS REFERENCE TO RELATED APPLICATIONS

This application is entitled to and claims the benefit of Japanese Patent Application No. 2012-142004 filed on Jun. 25, 2012, the disclosure of which including the specification, drawings and abstract is incorporated herein by reference in its entirety.

### BACKGROUND OF THE INVENTION

1. Field of the Invention

The present invention relates to an image forming apparatus.

2. Description of Related Art

Generally, in an image forming apparatus that forms an image by using an electrophotographic process, the surface of an image bearing member such as a photoconductor drum and a photoconductor belt (in the following description, photoconductor drum) is electrically charged to a predetermined potential, and an light exposure is performed on the surface to form an electrostatic latent image. Then, the latent image on the surface of the photoconductor drum is developed by a development section by using a developer (toner), and visualized as a toner image. The toner image thus obtained is transferred onto a recording sheet conveyed to the photoconductor drum, the recording sheet carrying the toner image is conveyed to a fixing device, and an unfixed toner image on the recording sheet is thermally fixed by the fixing device, thereby forming an image on the recording sheet.

As a technique relating to image forming apparatuses, a technique has been proposed in which a rotating brush is brought into contact with a charging roller to clean the charging roller (see Japanese Patent Application Laid-Open No. 2009-80392, for example). In addition, a technique has been proposed in which a charging brush is allowed to follow a photoconductor drum, thereby reducing generation of a brush line and a wound line on an image (see Japanese Patent Application Laid-Open No. 2011-180245, for example).

However, in an image forming apparatus in which a toner image is formed on a photoconductor drum, the surface of a photoconductor drum is degraded when image forming is repetitively performed. Generally, it is considered that ozone and/or nitrogen oxide are generated on the surface of a photoconductor drum in a charging step. In addition, it is considered that, also in a transferring step, ozone and/or nitrogen oxide are generated due to separation discharge in the case where the amount of charge of the toner is great. Ozone and/or nitrogen oxide thus generated become a factor that causes degradation of the surface of a photoconductor drum. Further, the ozone and/or nitrogen oxide also cause image defects such as image blurring and image flowing. In particular, image defect due to blurring significantly occurs in the case where an image is formed under a high temperature and humidity environment. This is because, when ozone and/or nitrogen oxide generated on the surface of the photoconductor drum are combined with moisture in the air, electric resistance on the surface of the photoconductor drum decreases, and thus retention of the electric charge on the photoconductor drum becomes difficult.

In addition, in the case where small-sized toner particles, toner wax molten by factors such as heat and pressure, etc. occur on the surface of the photoconductor drum as a filming matter which cannot be sufficiently removed by a roller and a blade of a blade cleaning system, such a filming matter adheres to the surface of the photoconductor drum. The filming matter deteriorates the adhesion of toner, and cause void on an image.

Thus, in order to prevent the above-mentioned image defect from occurring, it is necessary to remove a degraded layer on the surface of the photoconductor drum by polishing the surface of the photoconductor drum. When the degraded layer on the surface of the photoconductor drum is to be removed using a brush (for example, application brush) in contact with the photoconductor drum, the whole brush needs to have a high grazing force. However, in the case where the grazing force against the surface of the photoconductor drum is increased by increasing the stiffness of each one of bristles of the brush, or to be more specific, by thickening the bristle of the brush, shortening the length of the bristle, or the like, there is a problem that scars, which are formed by being deeply scraped off, are ununiformly formed on the photoconductor drum, causing image defect.

### SUMMARY OF THE INVENTION

An object of the present invention is to provide an image forming apparatus that can remove a degraded layer on the surface of an image bearing member without forming a scar on the image bearing member.

In order to achieve the object, an image forming apparatus reflecting one aspect of the present invention comprises: a rotatable image bearing member; and a brush roller that rotates in a counter direction to a rotational direction of the image bearing member with a bristle portion being in sliding contact with an image bearing surface of the image bearing member, wherein the bristle portion is inclined forward in the rotational direction of the brush roller.

Preferably, in the above-mentioned image forming apparatus, bristles of the bristle portion are each curved in an arc-like form from a root portion to a tip portion thereof in such a manner that the bristles are inclined forward in the rotational direction of the brush roller.

Preferably, in the above-mentioned image forming apparatus, bristles of the bristle portion are obliquely implanted in such a manner that the bristles are inclined forward in the rotational direction of the brush roller.

Preferably, in the above-mentioned image forming apparatus, the brush roller is an application brush roller.

Preferably, in the above-mentioned image forming apparatus, the brush roller is a cleaning brush roller.

Preferably, in the above-mentioned image forming apparatus, at least one of the image bearing member and the brush roller rotates backward when an image forming process of the image forming apparatus is stopped.

### BRIEF DESCRIPTION OF DRAWINGS

The present invention will become more fully understood from the detailed description given hereinbelow and the appended drawings which are given by way of illustration only, and thus are not intended as a definition of the limits of the present invention, and wherein:

FIG. 1 is a vertical sectional view of an image forming apparatus of the present embodiment;

FIG. 2 is a control block diagram of the image forming apparatus of the present embodiment;

FIG. 3 illustrates a configuration of a lubricant applying device of the present embodiment;

FIG. 4 illustrates an exemplary bristle inclination process for an application brush roller;

FIG. 5A illustrates another exemplary bristle inclination process for the application brush roller;

FIG. 5B illustrates another exemplary bristle inclination process for the application brush roller;

FIG. 6 illustrates a method of measuring a grazing force of the application brush roller;

FIG. 7 illustrates a modification of a configuration of the application brush roller;

FIG. 8A illustrates a modification of an operation of the lubricant applying device; and

FIG. 8B illustrates a modification of an operation of the lubricant applying device.

### DESCRIPTION OF THE PREFERRED EMBODIMENTS

The present embodiment will now be described in detail with reference to the accompanying drawings.

### [Configuration of Image Forming Apparatus 100]

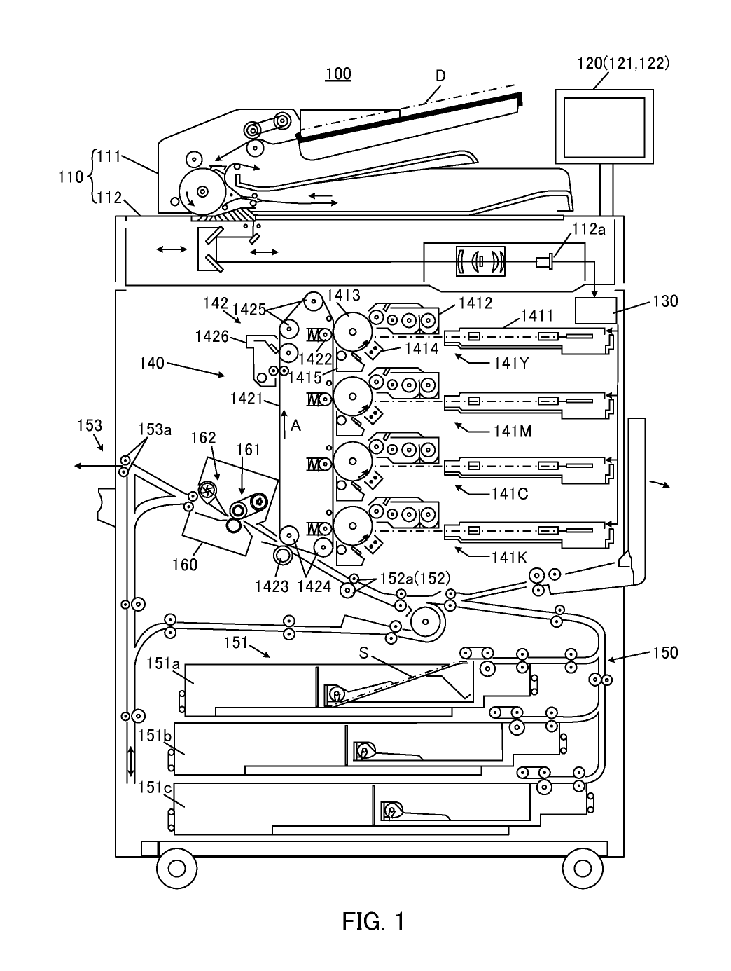

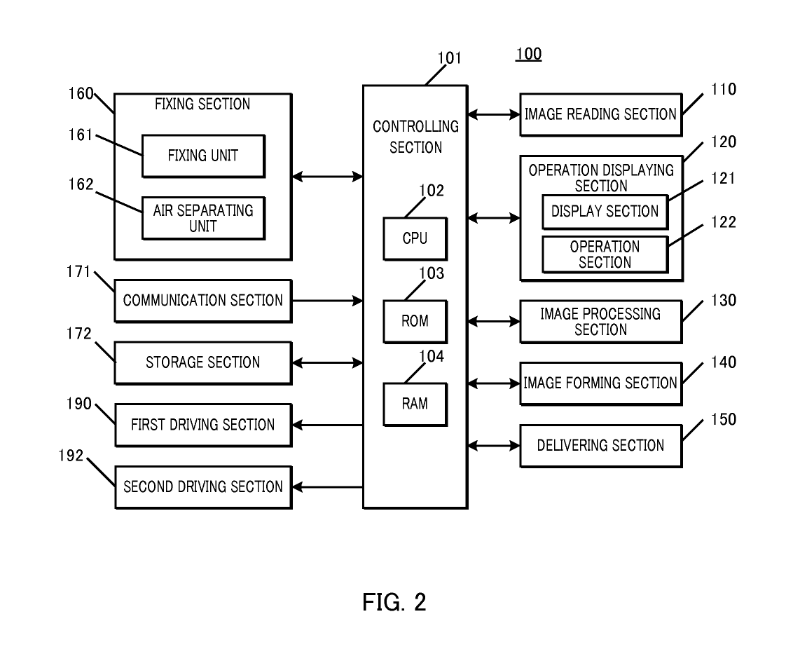

Image forming apparatus 100 illustrated in FIGS. 1 and 2 is a color image forming apparatus of an intermediate transfer type that utilizes the electrophotographic process technology. That is, image forming apparatus 100 transfers toner images of respective colors of C (cyan), M (magenta), Y (yellow), and K (black) formed on a photoconductor onto an intermediate transfer member (primary transfer), superposes the toner images of the four colors on the intermediate transfer member, and then transfers the images onto a recording sheet (secondary transfer), thereby forming an image.

In addition, image forming apparatus 100 employs a tandem type in which photoconductors corresponding to the four colors of C, M, Y, and K are disposed in series along a travelling direction of an intermediate transfer member, and toner images of respective colors are sequentially transferred onto the intermediate transfer member in a single procedure.

As illustrated in FIG. 2, image forming apparatus 100 includes controlling section 101, image reading section 110, operation displaying section 120, image processing section 130, image forming section 140, conveying section 150, fixing section 160, first driving section 190, and second driving section 192.

Controlling section 101 includes central processing unit (CPU) 102, read only memory (ROM) 103, random access memory (RAM) 104, and the like. CPU 102 reads out a program corresponding to the content of processing from ROM 103, loads the program in RAM 104, and performs a centralized control of operations of the blocks of image forming apparatus 100 in conjunction with the loaded program. At this time, various kinds of data stored in storage section 172 are referenced. Storage section 172 is composed of a nonvolatile-semiconductor memory (so-called flash memory) or a hard disk drive, for example.

Controlling section 101 exchanges various kinds of data, via communication section 171, with an external apparatus (for example, a personal computer) connected through a communication network such as local area network (LAN) and wide area network (WAN). For example, controlling section 101 receives image data (input image data) sent from an external device, and forms an image on a recording sheet based on the received image data. Communication section 171 is composed of a communication control card such as a LAN card, for example.

Image reading section 110 includes an automatic document feeder 111 called auto document feeder (ADF), document image scanning device 112, and the like.

Automatic document feeder 111 conveys a document D placed on a document tray by a conveying mechanism and outputs the document D to document image scanning device 112. When multiple documents D are placed on the document tray, automatic document feeder 111 can successively read images (including images on both sides) of the documents D at one time.

Document image scanning device 112 optically scans a document conveyed onto a contact glass from automatic document feeder 111 or a document placed on the contact glass, brings light reflected from the document into an image on a light reception surface of charge coupled device (CCD) sensor 112a, and reads the image of the document. Image reading section 110 generates data of the input image based on results of the reading of document image scanning device 112. The data of the input image is subjected to a predetermined image process at image processing section 130.

Operation displaying section 120 is a liquid crystal display (LCD) provided with a touch panel for example, and functions as display section 121 and operation section 122. Display section 121 displays states of various kinds of operation screens and images, operating conditions of functions, and the like according to a display control signal input from controlling section 101. Operation section 122 includes various kinds of operation keys such as numeric keys and a start key, receives various kinds of inputting operation by a user, and outputs an operation signal to controlling section 101.

Image processing section 130 includes a circuit that performs, on the input image data, a digital image process according to an initial setting or user setting, and the like. For example, under the control of controlling section 101, image processing section 130 performs a tone correction based on tone correction data (tone correction table). In addition, image processing section 130 performs, on the input image data, various kinds of corrections such as, other than the tone correction, a color correction, a shading correction, a compression process, and the like. Image forming section 140 is controlled based on the image data having been subjected to the foregoing processes.

Image forming section 140 includes image forming units 141Y, 141M, 141C, and 141K that form, based on the input image data, images of colored toners of Y component, M component, C component, and K component, intermediate transfer unit 142, and the like.

Image forming units 141Y, 141M, 141C, and 141K for Y component, M component, C component, and K component have configurations similar to each other. For convenience in illustration of the drawings and description, common components are denoted by the same reference numerals, and in the case where descriptions are separately given, Y, M, C or K is attached to the reference numeral. In FIG. 1, reference numerals are given only for elements of image forming unit 141Y for Y component, and reference numerals for elements of image forming units 141M, 141C, and 141K are omitted.

A configuration of image forming units 141 is described by taking image forming unit 141Y as an example. Image forming unit 141Y includes light exposure device 1411, developing device 1412, photoconductor drum 1413 that functions as an image bearing member, charging device 1414, drum cleaning device 1415, and the like.

Photoconductor drum 1413 includes a photoconductive layer, for example. The photoconductive layer is composed of a polycarbonate resin or the like containing an organic photoconductive material, and is provided on a metal base having a drum shape.

Charging device 1414 negatively charges the entire surface of photoconductor drum 1413. Light exposure device 1411 is composed of a semiconductor laser, for example, and irradiates laser light corresponding to the image of each color component onto photoconductor drum 1413. Positive electric charge is generated in a charge generation layer of photoconductor drum 1413, and is transported to the surface of the charge transport layer, whereby the electric charge (negative electric charge) on the surface of photoconductor drum 1413 is neutralized. Electrostatic latent images for the respective color components are formed on the surface of photoconductor drum 1413 due to a potential difference from the surrounding area.

Developing device 1412 contains therein developers of the color components (for example, two-component developers each composed of a toner having a small particle size and a magnetic carrier), and causes toner of each color component to adhere onto the surface of photoconductor drum 1413 so as to visualize an electrostatic latent image, thereby forming a toner image.

Drum cleaning device 1415 includes a drum cleaning blade to be brought into sliding contact with the surface of photoconductor drum 1413. Residual toner remaining on the surface of photoconductor drum 1413 after the primary transfer is scraped and removed by the drum cleaning blade.

Intermediate transfer unit 142 includes intermediate transfer belt 1421 serving as an intermediate transfer member, primary transfer roller 1422, secondary roller 1423, drive roller 1424, driven roller 1425, belt cleaning device 1426, and the like.

Intermediate transfer belt 1421 is composed of an endless belt, and is installed in a stretched state between drive roller 1424 and driven roller 1425. Intermediate transfer belt 1421 moves in an arrow A direction at a constant speed along with the rotation of drive roller 1424. When intermediate transfer belt 1421 is brought into pressure contact with photoconductor drum 1413 by primary transfer roller 1422, color toner images are superposed in sequence and thereby primary-transferred onto intermediate transfer belt 1421. Then, intermediate transfer belt 1421 is brought into pressure contact with a recording sheet S by secondary roller 1423, whereby the toner images primary-transferred on intermediate transfer belt 1421 are secondary-transferred on the recording sheet S.

Belt cleaning device 1426 includes a belt cleaning blade to be brought into sliding contact with the surface of intermediate transfer belt 1421. Residual toner remaining on the surface of intermediate transfer belt 1421 after the secondary transfer is scraped and removed by the belt cleaning blade.

Fixing section 160 applies heat and pressure to the recording sheet S conveyed thereto at a fixing nip portion, thereby fixing the toner images on the recording sheet S. Fixing section 160 is a fixing device of an air separation type including fixing unit 161 and air separating unit 162. Fixing unit 161 allows the recording sheet S to pass through the fixing nip portion formed by a pair of fixing members brought into pressure contact with each other, and applies heat of a heat source to the toner images transferred on the recording sheet S, thereby fixing the toner images onto the recording sheet S. Air separating unit 162 blows gas to the recording sheet S from an eject side of the recording sheet S in the fixing nip portion so as to separate the recording sheet S from the fixing members.

Conveying section 150 includes sheet feed section 151, conveying mechanism 152, sheet ejecting section 153, and the like. Recording sheets (standard type sheets and special type sheets) S each discriminated based on the basis weight, size, and the like thereof are stored, according to predetermined types, in respective sheet tray units 151a to 151c configuring sheet feed section 151.

The recording sheets S stored in sheet tray units 151a to 151c are output one by one from the uppermost, and conveyed to image forming section 140 by conveying mechanism 152 including a plurality of conveying rollers such as registration rollers 152a. At this time, a registration section in which registration rollers 152a are arranged corrects the obliqueness of the fed recording sheet S and adjusts the conveyance timing. Then, in image forming section 140, the toner image on intermediate transfer belt 1421 is secondary-transferred onto a surface of the recording sheet S, and a fixing step is performed in fixing section 160. The recording sheet S on which an image has been formed is ejected from image forming apparatus 100 by sheet ejecting section 153 including sheet ejecting roller 153a.

Under the control of controlling section 101, first driving section 190 rotates photoconductor drum 1413. Under the control of controlling section 101, second driving section 192 rotates application brush roller 182 described later. First driving section 190 and second driving section 192 are each composed of a motor and the like, for example.

### [Configuration of Lubricant Applying Device 180]

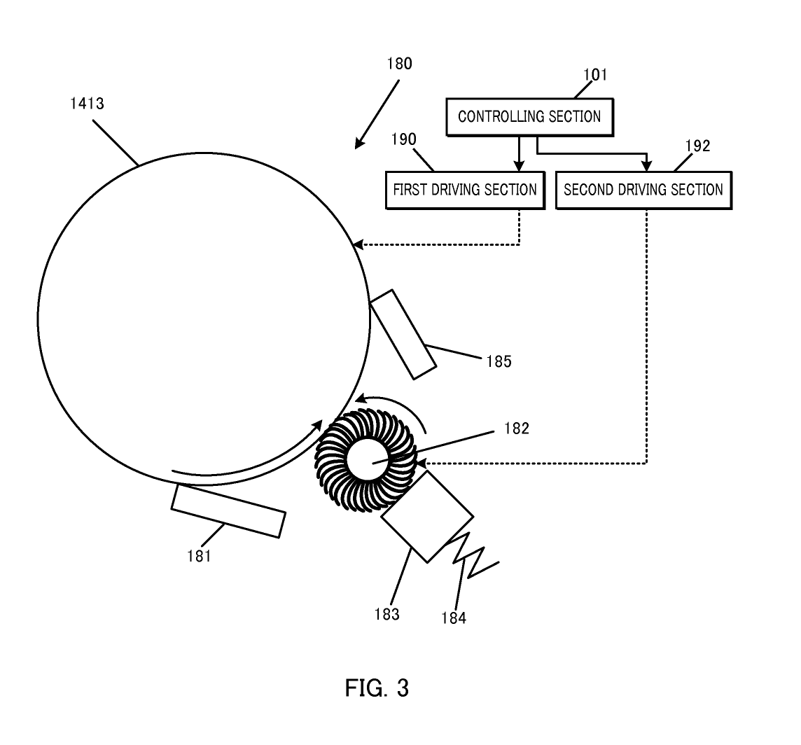

In the present embodiment, as illustrated in FIG. 3, lubricant applying device 180 that applies lubricant 183 to photoconductor drum 1413 is provided on the downstream side of cleaning blade 181 with respect to the rotational direction of photoconductor drum 1413.

Lubricant applying device 180 includes application brush roller 182, lubricant 183, pressing spring 184, and leveling member 185. Lubricant applying device 180 is provided for each of image forming units 141Y, 141M, 141C, and 141K.

Application brush roller 182 has a configuration in which a base cloth having a thickness of 0.5 [mm], on which bundles of acrylic fibers are weaved in a loop form and implanted so as to have a height of 3.5 [mm], is wound around a mandrel (hereinafter referred to as base) made of metal having an outer diameter of 6 [mm]. The acrylic fibers have a fineness of 3 [denier] and a density of 150 [kF/inch²]. Application brush roller 182 is disposed in such a manner that photoconductor drum 1413 is pressed into application brush roller 182 by 1.0 [mm]. Photoconductor drum 1413 rotates in a counterclockwise direction in the drawing at, for example, 400 [mm/sec]. Application brush roller 182 rotates in the same direction as photoconductor drum 1413 (i.e., in a counter direction) at, for example, 280 [mm/sec], with brush fibers (hereinafter referred to as bristle portion) being in sliding contact with the image bearing surface of photoconductor drum 1413.

Photoconductor drum 1413 is driven into rotation by first driving section 190 having received a control signal from controlling section 101. Application brush roller 182 is driven into rotation by second driving section 192 having received a control signal from controlling section 101.

Lubricant 183 is formed of solidified zinc stearate (ZnSt) or the like having a hardness equivalent to pencil hardness HB. In a depth direction in the drawing, lubricant 183 has a length substantially equal to the axial length of photoconductor drum 1413, and lubricant 183 is pressed toward application brush roller 182 by pressing spring 184. Pressing spring 184 is fixed at its right end section in the drawing to a housing not illustrated in the drawing. In addition, a plurality of the pressing springs 184 are disposed with a good balance along the axial direction of application brush roller 182.

Application brush roller 182 rotates to scrape lubricant 183 by using its brush fibers, and applies fine powder of the scraped lubricant 183 to the surface of photoconductor drum 1413. Leveling member 185 is a blade provided on the downstream side of application brush roller 182 with respect to the rotational direction of photoconductor drum 1413. Leveling member 185 uses application brush roller 182 to equalize the distribution of lubricant 183 applied on the surface of photoconductor drum 1413 by application brush roller 182.

The bristle portion of application brush roller 182 is inclined forward in the rotational direction of application brush roller 182. Specifically, bristles of the bristle portion are each curved in an arc-like form from its root portion to tip portion in such a manner that the bristles are inclined forward in the rotational direction of application brush roller 182.

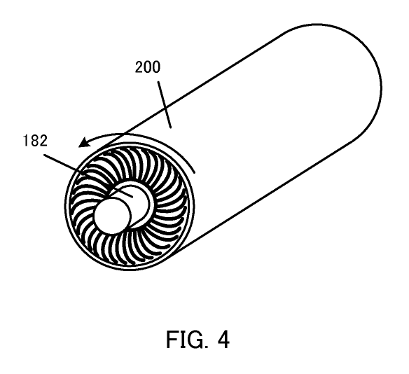

Next, a method for inclining the bristle portion is described. For example, as illustrated in FIG. 4, application brush roller 182 having the bristle portion implanted in the radial direction of the base is installed in cylindrical body 200 having an inner diameter slightly smaller than the outer diameter of application brush roller 182. Subsequently, cylindrical body 200 is rotated for a certain period of time, thereby inclining the bristle portion.

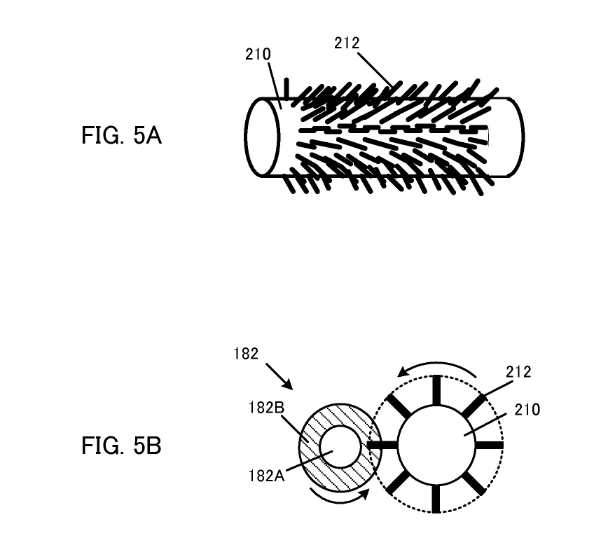

Alternatively, metal brush roller 210 illustrated FIG. 5A may be used to incline the bristle portion. A large number of metal spines 212 are disposed on the outer periphery surface of metal brush roller 210. FIG. 5B illustrates a process for inclining bristle portion 182B by using metal brush roller 210. To be more specific, in a state where metal brush roller 210 is pressed into application brush roller 182 having bristle portion 182B implanted in the radial direction of base 182A by a predetermined amount (for example, 3.0 [mm]), application brush roller 182 and metal brush roller 210 are rotated in the counterclockwise direction in the drawing. It is to be noted that bristle portion 182B may be obliquely implanted on base 182A without using cylindrical body 200 and metal brush roller 210.

Owing to the bristle inclination processes illustrated in FIGS. 4 and 5, a difference in stiffness of bristle portion 182B is caused depending on the rotational direction of application brush roller 182 (i.e., depending on clockwise direction or counterclockwise direction). To be more specific, the stiffness of bristle portion 182B is greater in the case where application brush roller 182 rotates in a counter direction with respect to photoconductor drum 1413 (i.e., a direction same to the rotational direction of photoconductor drum 1413 such that application brush roller 182 and photoconductor drum 1413 move in the opposite direction at their contact point) than in the case where application brush roller 182 rotates in an accompanying direction with respect photoconductor drum 1413 (i.e., a direction opposite to the rotational direction of photoconductor drum 1413 such that application brush roller 182 and photoconductor drum 1413 move in the same direction at their contact point). When a difference in stiffness of bristle portion 182B is caused, in rotating photoconductor drum 1413 and application brush roller 182, a difference in load (pressing force) applied by application brush roller 182 to photoconductor drum 1413 is also caused.

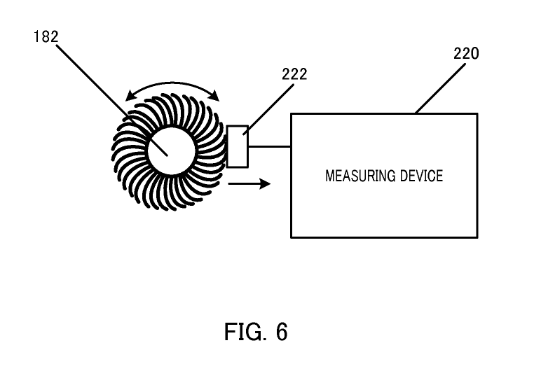

FIG. 6 illustrates an example of a process for measuring a pressing force received from application brush roller 182 in rotation by using, for example, measuring device 220 which is a load cell or the like. Specifically, a surface of measuring terminal 222 is pressed against bristle portion 182B of application brush roller 182, and application brush roller 182 is rotated in the clockwise direction or the counterclockwise direction at 60 [rpm]. Since it is desirable that the pressing amount of measuring terminal 222 corresponds to the condition of application brush roller 182 mounted in image forming apparatus 100, the pressing amount of measuring terminal 222 is so set as to correspond to the pressing amount of photoconductor drum 1413 into application brush roller 182 (1.0 [mm]). In this case, the force of bristle portion 182B of application brush roller 182 pushing back measuring terminal 222 is measured as a pressing force. As a result of the measurement, the pressing force is 90 [mN/cm] when application brush roller 182 is rotated in the clockwise direction. On the other hand, the pressing force is 250 [mN/cm] when application brush roller 182 is rotated in the counterclockwise direction. In this manner, the difference in pressing force applied by application brush roller 182 to photoconductor drum 1413 is caused, and the difference in a grazing force (or scraping force) applied on the surface of photoconductor drum 1413 is also caused depending on a rotational direction of application brush roller 182.

It is to be noted that, when the photoconductor layer of photoconductor drum 1413 is made of polycarbonate, the fineness of the bristle portion is desirably 2 to 9 [denier], more preferably, 3 to 6 [denier]. Preferably, the stiffness of bristle portion 182B is adjusted depending on the photoconductive layer of photoconductor drum 1413. Desirably, the linear velocity ratio of photoconductor drum 1413 to application brush roller 182 (=a linear velocity of application brush roller 182/a linear velocity of photoconductor drum 1413) is about 0.3 to 0.9.

### Effect of the Present Embodiment

As has been described in detail, the image forming apparatus according to the present embodiment includes rotatable photoconductor drum 1413, and application brush roller 182 that rotates in a counter direction to the rotational direction of photoconductor drum 1413, with bristle portion 182B being in sliding contact with the image bearing surface of photoconductor drum 1413. Bristle portion 182B is inclined forward in the rotational direction of application brush roller 182. Specifically, the bristles of bristle portion 182B are each curved in an arc-like form from its root portion to tip portion in such a manner that the bristles are inclined forward in the rotational direction of application brush roller 182.

In the present embodiment having the above-mentioned configuration, without increasing the stiffness of each one of the bristles of bristle portion 182B, a grazing force of application brush roller 182 against the surface of photoconductor drum 1413 can be sufficiently ensured by using application brush roller 182 including bristle portion 182B whose stiffness differs depending on the rotational direction. Consequently, a degraded layer on the surface of photoconductor drum 1413 can be removed without forming a scar on photoconductor drum 1413.

### Modification of the Present Embodiment

It is to be noted that, in the above-mentioned embodiment, application brush roller 182 functions as a brush roller of the present invention, but the present invention is not limited to this. Alternatively, a cleaning brush roller in contact with the surface of photoconductor drum 1413 may function as the brush roller of the present invention, for example.

In addition, in the above-mentioned embodiment, photoconductor drum 1413 functions as an image bearing member of the present invention, but the present invention is not limited to this. Alternatively, an endless photoconductor belt wound around two rollers may function as an image bearing member of the present invention, for example.

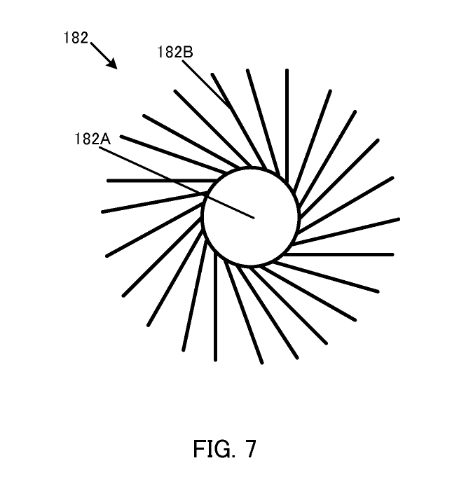

In addition, in the above-mentioned embodiment, the bristles of the bristle portion are each curved in an arc-like form from its root portion to tip portion in such a manner that the bristles are inclined forward in the rotational direction of application brush roller 182, but the present invention is not limited to this. Alternatively, the bristles of bristle portion 182B may be obliquely implanted in such a manner that the bristles are inclined forward in the rotational direction of application brush roller 182 as illustrated in FIG. 7, for example. In this case, the bristles of bristle portion 182B are implanted on base 182A in such a manner that the bristles are inclined at a predetermined angle (for example, 45 degrees) relative to the radial direction with respect to the rotational axis of application brush roller 182 from its root portion to tip portion with respect to base 182A of application brush roller 182. It should be noted, however, that, in terms of preventing a scar from being formed on photoconductor drum 1413 by excessively increasing the grazing force against the surface of photoconductor drum 1413, it is desirable that the bristles of bristle portion 182B be each curved in an arc-like form from its root portion to tip portion with respect to the base 182A, or in other words, it is desirable that the contact angle of the tip portion of each bristle to photoconductor drum 1413 be not an acute angle.

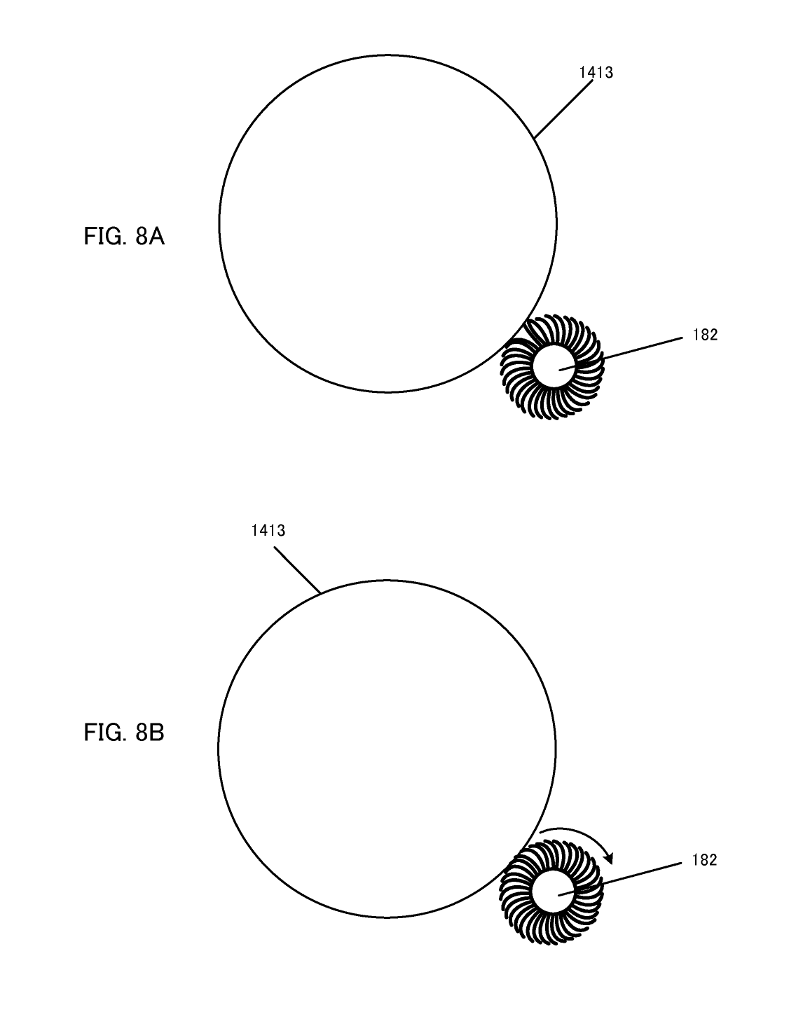

In addition, in the above-mentioned embodiment, when an image forming process of image forming apparatus 100 is stopped, controlling section 101 may control at least one of photoconductor drum 1413 and application brush roller 182 to rotate backward. Application brush roller 182 rotates in a counter direction to the rotational direction of photoconductor drum 1413 in a state where bristle portion 182B is inclined. Therefore, when the image forming process is stopped, bristle portion 182B is kept in a state where it is divided as illustrated in FIG. 8A, and bristle portion 182B is deformed to reflect such a state. That is, it is impossible to sufficiently ensure the grazing force of application brush roller 182 against the surface of photoconductor drum 1413. In view of this, it is preferable to cause application brush roller 182 to rotate backward as illustrated in FIG. 8B, for example. In particular, when the image forming process is stopped, if the rotations of photoconductor drum 1413 and application brush roller 182 are simultaneously stopped, there is a possibility that only photoconductor drum 1413 is rotated by the inertia force of photoconductor drum 1413. At this time, bristle portion 182B is more likely to be divided, and deformation reflecting such a state is likely to be made in bristle portion 182B. To avoid this, at least one of photoconductor drum 1413 and application brush roller 182 is rotated backward, so that the divided state of bristle portion 182B can be surely prevented from occurring.

It should be understood by those skilled in the art that various modifications, combinations, sub-combinations and alterations may occur depending on design requirements and other factors in so far as they are within the scope of the appended claims or the equivalents thereof.

What is claimed is:

1. An image forming apparatus comprising:
a rotatable image bearing member; and
a brush roller that rotates in a counter direction to a rotational direction of the image bearing member with a bristle portion being in sliding contact with an image bearing surface of the image bearing member, wherein
the bristle portion is inclined forward in the rotational direction of the brush roller.

2. The image forming apparatus according to claim 1, wherein bristles of the bristle portion are each curved in an arc-like form from a root portion to a tip portion thereof in such a manner that the bristles are inclined forward in the rotational direction of the brush roller.

3. The image forming apparatus according to claim 1, wherein bristles of the bristle portion are obliquely implanted in such a manner that the bristles are inclined forward in the rotational direction of the brush roller.

4. The image forming apparatus according to claim 1, wherein the brush roller is an application brush roller.

5. The image forming apparatus according to claim 1, wherein the brush roller is a cleaning brush roller.

6. The image forming apparatus according to claim 1, wherein at least one of the image bearing member and the brush roller rotates backward when an image forming process of the image forming apparatus is stopped.
